(19) United States
(12) Patent Application Publication
(10) Pub. No.: US 2011/0254741 A1
(43) Pub. Date: Oct. 20, 2011

(54) WIRELESS COMMUNICATION DEVICE WITH HOUSING MEMBER THAT FUNCTIONS AS A RADIATING ELEMENT OF AN ANTENNA

(76) Inventor: Katsunori Ishimiya, Tokyo (JP)

(21) Appl. No.: 12/761,591

(22) Filed: Apr. 16, 2010

(51) Int. Cl. H01Q 1/24; H01Q 9/04

(52) U.S. Cl. 343/702; 343/700 MS

(57) ABSTRACT

A wireless communication device includes a housing including a first exterior portion and a second exterior portion defining a space therebetween for mounting electronic circuitry within the housing. The second exterior portion of the housing includes a conductive layer having a first end and a second end opposite the first end, and a printed wiring board within the housing. The printed wiring board includes a ground plane and is spaced apart from the conductive layer. An antenna feed element electrically couples a lead on the printed wiring board to the conductive layer at a point that is displaced from the first end of the conductive layer towards a center of the conductive layer, and a ground connection electrically couples the conductive layer to the ground plane of the printed circuit board. The conductive layer may provide a conductive outer cover of the device.

### FIELD OF THE INVENTION

The present invention relates to wireless communication devices, and in particular relates to wireless communication devices including antennas.

### BACKGROUND

An Inverted F Antenna (IFA) is an omni-directional antenna that is particularly useful in mobile applications, such as mobile telephones, GPS receivers, and the like. An IFA is illustrated in FIG. 8. As shown therein, an IFA 30 includes a radiating element 32 that extends in parallel with a ground line 34. A short circuit stub 36 is provided between an end of the radiating element 32 and the ground line 34. Wireless signals are transmitted or received by the antenna through a feed point 38 that contacts the radiating element 32 at a point between opposing ends of the radiating element 32. Accordingly, the IFA has a relatively compact form while maintaining a desired resonant trace length. As can be seen from FIG. 8, the name “Inverted F Antenna” derives from the configuration of the radiating element 32, the short circuit stub 36 and the feed point 38.

The parallel configuration of the radiating element and the ground plane introduces capacitance to the input impedance of the antenna. This capacitance is compensated by the short-circuit stub.

Excitation of currents in the radiating element causes a corresponding excitation in the ground plane. The resulting electromagnetic field is formed by the interaction of the radiating element and an image of the radiating element below the ground plane.

A Planar Inverted “F” Antenna (PIFA) is a type of IFA in which the radiating element is planar. FIG. 9 is a schematic illustration of a PIFA 40 including a planar radiating element 42 positioned in parallel over a ground plane 44. The planar radiating element 42 is short circuited to the ground plane 44 by a short circuit plate 46 that is positioned at a first end of the planar radiating element 42. A feed point 48 contacts the radiating element 42 between respective first and second ends of the radiating element 42 at a point near an edge of the radiating element 42 running between the first and second ends of the radiating element 42.

Providing a planar radiating element may increase the bandwidth of the antenna. Furthermore, a PIFA may have moderate to high gain in both vertical and horizontal states of polarization, which may be advantageous in applications in which the antenna orientation is not fixed. However a PIFA typically has a relatively narrow bandwidth.

The bandwidth of a PIFA can be increased a number of ways, including reducing the size of the ground plane, inserting several slots at the ground plane edges, using a thick air substrate, using parasitic resonators with resonant lengths close to the main resonant frequency, adjusting the location and the spacing between two shorting posts, and other techniques that are designed to lower the quality factor (Q) of the antenna.

The size of a PIFA may be reduced by shortening the antenna. However, shortening the antenna affects the impedance at the antenna terminals such that the radiation resistance becomes reactive as well. This can be compensated with capacitive top loading. In practice, the missing antenna height may be replaced with an equivalent circuit, which improves the impedance match and the efficiency.

Capacitive loading may reduce the resonance length from λ/4 to less than λ/8 at the expense of bandwidth and good matching. A capacitive load can be produced by adding a plate (parallel to the ground) to produce a parallel plate capacitor.

The resonant frequency of a PIFA is affected, among other things, by the dimensions of the antenna, the width of the short circuit stub, and the height of the radiating element above the ground plane. The introduction of an open slot in the radiating element can reduce the resonant frequency of the antenna, and can also be used to provide an antenna for dual-frequency operation.

Impedance matching of a PIFA may be controlled by the positioning of the feed point and the short circuit stub.

### SUMMARY

A wireless communication device according to some embodiments includes a housing including a first exterior portion and a second exterior portion defining a space therebetween for mounting electronic circuitry within the housing. The second exterior portion of the housing includes a conductive layer having a first end and a second end opposite the first end. A printed wiring board is within the housing. The printed wiring board includes a ground plane and is spaced apart from the conductive layer. An antenna feed element electrically couples a lead on the printed wiring board to the conductive layer at a point that is displaced from the first end of the conductive layer towards a center of the conductive layer, and a ground connection electrically couples the conductive layer to the ground plane of the printed circuit board. The conductive layer may comprise a conductive outer cover of the wireless communication device.

The conductive layer may provide a radiating element of a planar inverted F antenna for the wireless communication device.

The wireless communication device may further include a display mounted on the front exterior portion of the housing and a conductive display frame configured to support the display. The conductive display frame may be electrically coupled to the ground plane of the printed circuit board and the ground connection may be connected to the display frame.

The ground connection may be located at the second end of the conductive layer.

The wireless communication device may further include an antenna feed point where the antenna feed element contacts the conductive layer on a first side of the conductive layer that runs between the first and second ends of the conductive layer, and a second ground connection on the first side of the conductive layer.

The wireless communication device may further include a third ground connection on a second side of the conductive layer opposite the first side of the conductive layer. The third ground connection may be provided opposite the antenna feed point.

The wireless communication device may further include a slot in the conductive layer extending from a side of the conductive layer towards a longitudinal centerline of the conductive layer. The slot may be free of conductive material. An antenna feed point where the antenna feed element contacts the conductive layer may be on a first side of the conductive layer that runs between the first and second ends of the conductive layer and may be adjacent the slot.

The ground connection may be located at the second end of the conductive layer.

The wireless communication device may further include a second ground connection on the first side of the conductive layer on an opposite side of the slot from the antenna feed point.

The wireless communication device may further include a third ground connection on a second side of the conductive layer opposite the first side of the conductive layer.

The third ground connection may be provided opposite the antenna feed point on the same side of the slot as the antenna feed point.

A housing for a wireless communication device according to some embodiments includes a first exterior portion and a second exterior portion defining a space therebetween for mounting electronic circuitry within the housing. The second exterior portion of the housing may include a conductive layer having a first end and a second end opposite the first end, and the second exterior portion may include an antenna feed point at a point that is displaced from the first end of the conductive layer towards a center of the conductive layer and that is configured to receive an antenna feed element connection. The housing further includes a ground connection point that is configured to electrically couple the conductive layer to a ground plane.

A wireless communication device according to further embodiments includes a housing including a conductive exterior surface, a ground plane within the housing and spaced apart from the conductive exterior surface, an antenna feed element that electrically couples an RF signal lead to the conductive exterior surface, and a ground connection that electrically couples the conductive exterior surface to the ground plane. The conductive exterior surface provides a radiating element of a planar inverted F antenna for the wireless communication device.

The ground plane may include a ground plane layer of a printed wiring board that is disposed within the housing. The wireless communication device may further include a ground plane extension that is electrically coupled to the ground plane, and the conductive exterior surface may be coupled to the ground plane through the ground plane extension.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIGS. 1A, 1B and 1C illustrate a wireless communication device according to some embodiments.

FIGS. 2A and 2B illustrate a wireless communication device according to further embodiments.

FIG. 3 is a block diagram that illustrates electronic components of a wireless communication device according to some embodiments.

FIGS. 4A and 4B are cross-sectional diagrams that illustrate wireless communication devices according to some embodiments.

FIGS. 5A, 5B, 5C and 5D illustrate antenna radiating elements of wireless communication devices according to some embodiments.

FIG. 6 illustrates return loss (S11) measurements for a wireless communication device according to some embodiments.

FIG. 7 illustrates efficiency measurements for a wireless communication device according to some embodiments at various frequency bands.

FIG. 8 illustrates an inverted F antenna.

FIG. 9 illustrates a planar inverted F antenna.

FIGS. 10A and 10B are partial cross sectional illustrations of a wireless device according to some embodiments and a conventional wireless device.

FIGS. 11A and 11B illustrates a radiating element according to some embodiments and a radiating element in a conventional wireless device.

FIG. 12 illustrates vertical and horizontal radiation patterns for emissions from a device according to some embodiments using GSM900 signals, DCS 1750 MHz signals, and UMTS Band I 2110 MHz signals.

### DETAILED DESCRIPTION OF EMBODIMENTS

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As used herein, a “wireless communication device” includes, but is not limited to, a device that is configured to receive/transmit communication signals via a wireless interface with, for example, a cellular network, a wireless local area network (WLAN), a digital television network such as a DVB-H network, a satellite network, an AM/FM broadcast transmitter, and/or another communication terminal. A wireless communication device may be referred to as a “wireless communication terminal,” a “wireless terminal” and/or a “mobile terminal.” Examples of wireless communication devices include, but are not limited to, a satellite or cellular radiotelephone; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver.

Wireless communication between electronic devices may be accomplished using a wide variety of communication media, communication systems and communication standards. For example, mobile terminals such as wireless mobile telephones are typically configured to communicate via analog and/or digital wireless radio frequency (RF) telephone systems. Such devices may additionally be configured to communicate using wired and/or wireless local area networks (LANs), short range communication channels, such as Bluetooth RF communication channels and/or infrared communication channels, and/or long range communication systems, such as satellite communication systems.

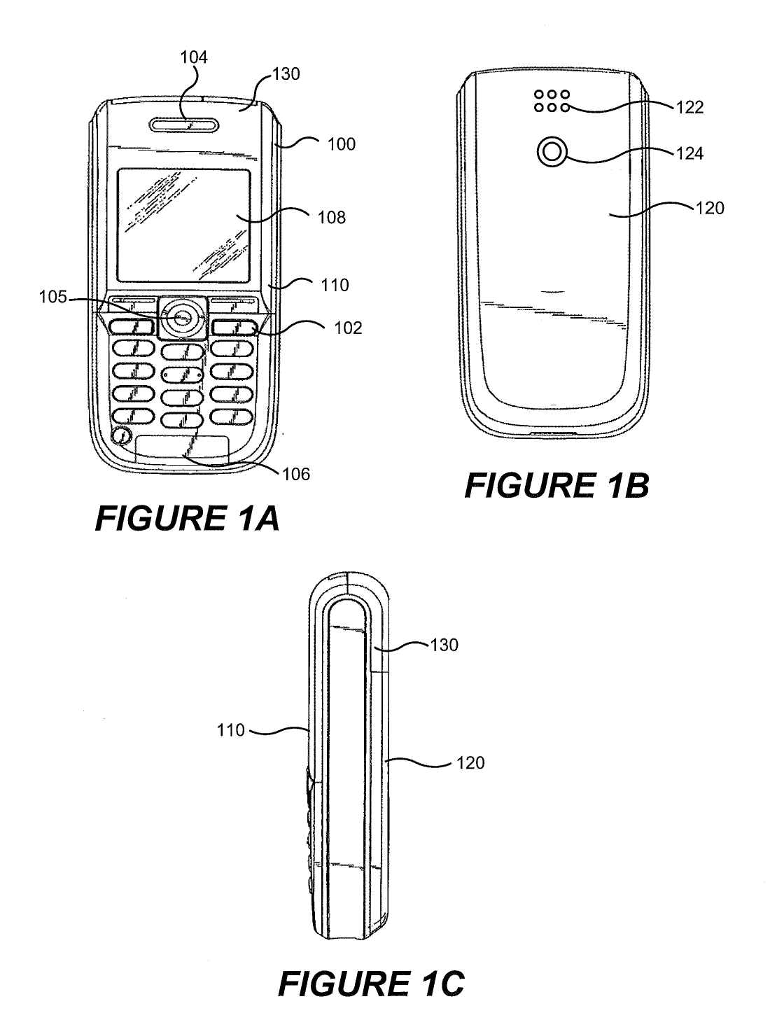

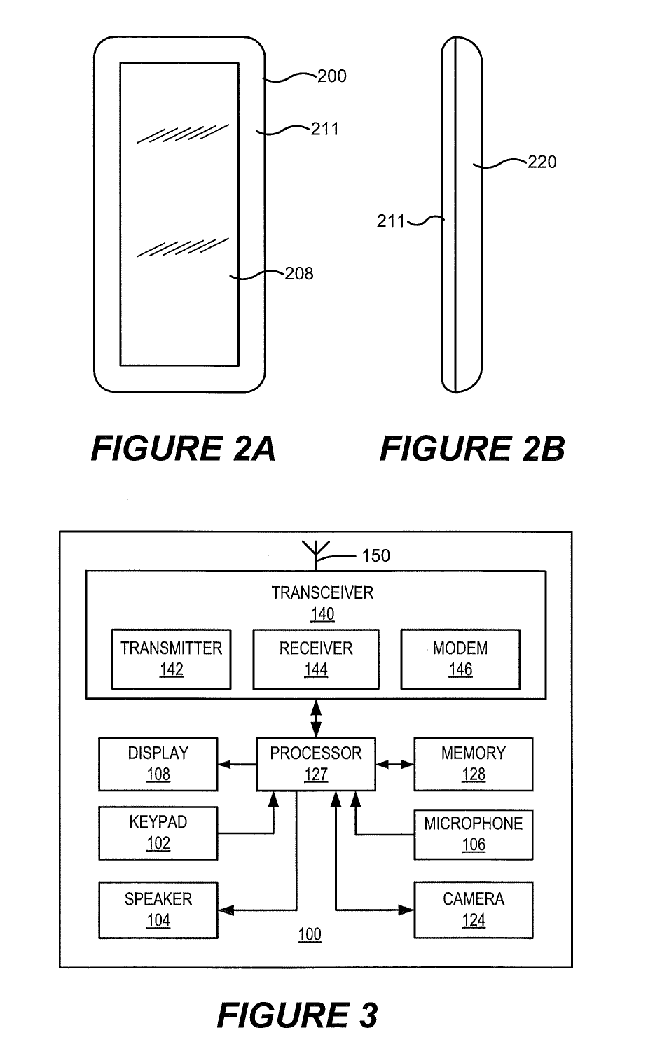

A wireless communication device 100 according to some embodiments is illustrated in FIGS. 1A to 1C. FIG. 2 is a block diagram illustrating electronic components that may be included in a wireless communication device 100 according to some embodiments. FIGS. 3A and 3B illustrate an optional configuration of a wireless communication device according to some embodiments.

In particular, the wireless communication device 100 is configured to transmit and/or receive wireless signals over one or more wireless communication interfaces. For example, a wireless communication device 100 according to some embodiments can include a cellular communication module, a Bluetooth module, an infrared communication module, a global positioning system (GPS) module, a WLAN module, and/or other types of communication modules.

With a cellular communication module, the wireless communication device 100 can communicate using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS).

With a Bluetooth or infrared module, the wireless communication device 100 can communicate via an ad-hoc network using a direct wireless interface. With a WLAN module, the wireless communication device 100 can communicate through a WLAN router using a communication protocol that may include, but is not limited to, 802.11a, 802.11b, 802.11e, 802.11g, and/or 802.11i.

A wireless communication device 100 my additionally include an AM/FM radio tuner, a UHF/VHF tuner, a satellite radio tuner, a DVB-H receiver, and/or another receiver configured to receive a broadcast audio/video signal and/or data signal.

The wireless communication device 100 includes a housing 130 that houses and protects the electronics of the wireless communication device 100. In some embodiments, the housing 130 includes a first housing portion, or front housing, 110, and a second housing portion, or rear housing 120.

The wireless communication device 100 includes a display 108, such as a liquid crystal display (LCD) and/or an organic light emitting diode (OLED) display, which may be positioned on the front housing 110 of the device 100. The wireless communication device 100 may optionally include a keypad 102 or other user input mechanism on the front housing 110 of the device 100. In some embodiments, the display 108 may be provided with touchscreen capability to replace and/or supplement the keypad 102.

The wireless communication device 100 may further include a multifunction control/input button 105 that can be used to select menu items and/or to input commands to the wireless communication device 100.

The wireless communication device 100 may include a microphone 106 and an earphone/speaker 104. The front housing 110 may be designed to form an acoustic seal to the user's ear when the earphone/speaker 104 is placed against the user's head.

Referring to FIG. 1B, a rear speaker 122 and/or a camera lens 124 for a digital camera may be optionally be provided on the rear housing 120.

A wireless communication device according to some embodiments can have a variety of shapes, sizes and housing types. For example, in some embodiments, the wireless communication device 100 may include a flip-style mobile terminal in which the front housing 110 and the rear housing 120 are rotatably connected by means of a rotating hinge, or a slide-style mobile terminal in which the front housing 110 and the rear housing 120 are connected by means of a sliding hinge.

A wireless communication device according to further embodiments can have a configuration as illustrated in FIGS. 2A and 2B. As shown therein, a wireless communication device 200 may have a housing that includes a front display frame 211 and a rear housing 220. The front display frame 211 provides mechanical support for a touchscreen display 208 that covers a major portion of the front of the device 200.

Referring to FIG. 3, the keypad 102, display 108, microphone 106, speaker 104 and camera 124 may be coupled to a processor 127, such as a microprocessor or microcontroller, which may be configured to control operations of the device 100. The device 100 may further include a transceiver 140 and a memory 128 coupled to the processor 127. Other electronic circuitry, such as a WLAN communication interface, a Bluetooth interface, a GPS interface, a digital signal processor, etc., may also be included in the electronic circuitry of the device 100.

The transceiver 140 typically includes a transmitter circuit 142, a receiver circuit 144, and a modem 146, which cooperate to transmit and receive radio frequency signals to remote transceivers via an antenna 150. The radio frequency signals transmitted between the device 100 and the remote transceivers may comprise both traffic and control signals (e.g., paging signals/messages for incoming calls), which are used to establish and maintain communication with another party or destination.

The memory 128 may be a general purpose memory that is used to store both program instructions for the processor 127 as well as data, such as audio data, video data, configuration data, and/or other data that may be accessed and/or used by the processor 127. The memory 128 may include a nonvolatile read/write memory, a read-only memory and/or a volatile read/write memory. In particular, the memory 128 may include a read-only memory in which basic operating system instructions are stored, a non-volatile read/write memory in which re-usable data, such as configuration information, directory information, and other information may be stored, as well as a volatile read/write memory, in which short-term instructions and/or temporary data may be stored.

Embodiments of the present invention provide a wireless communication device including a Planar Inverted F Antenna (PIFA). Because of its physical and electrical characteristics, a PIFA may be particularly well suited for mobile wireless applications. However, providing a PIFA within a housing of a mobile wireless communication device may undesirably increase the overall thickness of the device and/or may limit the design of the antenna.

Accordingly, in some embodiments, a wireless communication device includes, a conductive cover that provides the radiating element for a planar antenna that is used by the device for communications. For example, the conductive cover can provide a rear housing of a wireless communication device according to some embodiments.

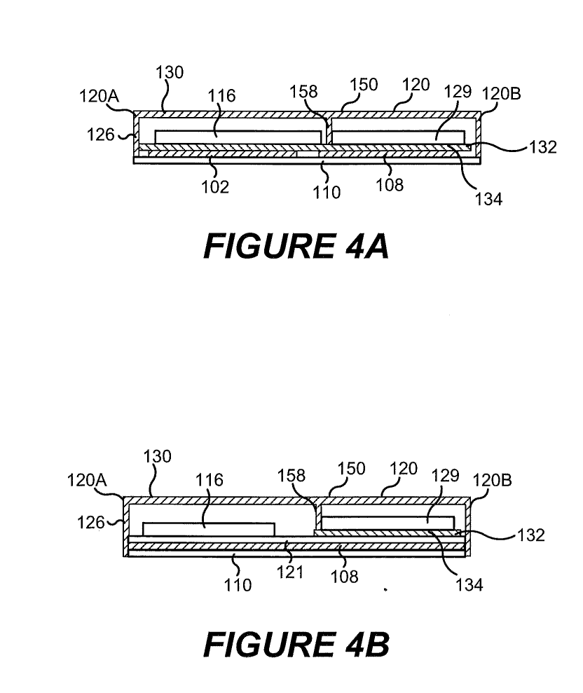

A wireless communication device 100 according to some embodiments is illustrated in cross section in FIG. 4A. As shown therein, a wireless communication device 100 according to some embodiments includes a housing 130 including a front cover 110 that provides a front exterior portion of the housing 130 and a rear cover 120 that provides a rear exterior portion of the housing 130. The front cover 110 and the rear cover 120 define a space therebetween in which electronic circuitry, such as the control electronics and communication electronics of the device, are provided. The electronic circuitry of the device 100 may include, for example, one or more microcontrollers, transceivers, memories, communication controllers, etc.. The electronic circuitry may be provided, for example, in a shielding can 129 mounted on a substrate, such as a multilayer printed wiring board (PWB) or printed circuit board (PCB) 132.

A display 108 and a keypad 102 are mounted on the PWB 132, and a battery 116 is provided within the housing 130.

The rear cover 120 of the housing 130 is provided as a generally planar conductive piece having a first end 120A and a second end 120B opposite the first end. The rear cover may include a lightweight sheet of metal, such as copper, aluminum or any other suitable metal, having a thickness of about 0.01 mm to about 5 mm. The rear cover 120 may provide an external surface of the housing 130 that may be contacted by a user's hand when the device 100 is in use.

The printed wiring board 132 within the housing 130 provides a ground plane 134 that is spaced apart from the conductive rear cover 120. An antenna feed element 158 electrically couples an RF signal lead on the printed wiring board 132 to the conductive rear cover 120 at a point that is displaced from the first end 120A of the conductive rear cover 120 towards a center of the conductive rear cover 120. In some embodiments, the conductive rear cover may 120 may have a length from the first end 120A to the second end 120B of about 110 mm, and the antenna feed element may be positioned at a point that is displaced from the first end 120A of the conductive rear cover 120 by about 60 mm to about 70 mm.

A shorting plate 126 electrically couples the conductive rear cover 120 to the ground plane 134 of the printed wiring board 132 at the first end 120A of the conductive rear cover 120.

The conductive rear cover 120 thereby provides the radiating element of a planar inverted F antenna 150 for the wireless communication device 100 without taking up valuable space within the housing 130. A more compact and useful device may thereby be provided.

Referring to FIG. 4B, the PWB 132 may not extend over the full length of the device 100, but may be provided only at one end of the device 100. In some embodiments, a metal display frame 121 may be provided within or on the housing 130. The metal display frame 121 may provide mechanical support to the display 108 instead of or in addition to the PWB 132 providing support. The metal display frame 121 may be electrically coupled to the ground plane of the PWB 132 and may be configured to provide a ground plane extension for the antenna 150. In particular, the conductive rear cover 120 may be electrically connected to the metal display frame 121 via a shorting plate 126, and the metal display frame 121 may be coupled to the ground plane of the PWB 132.

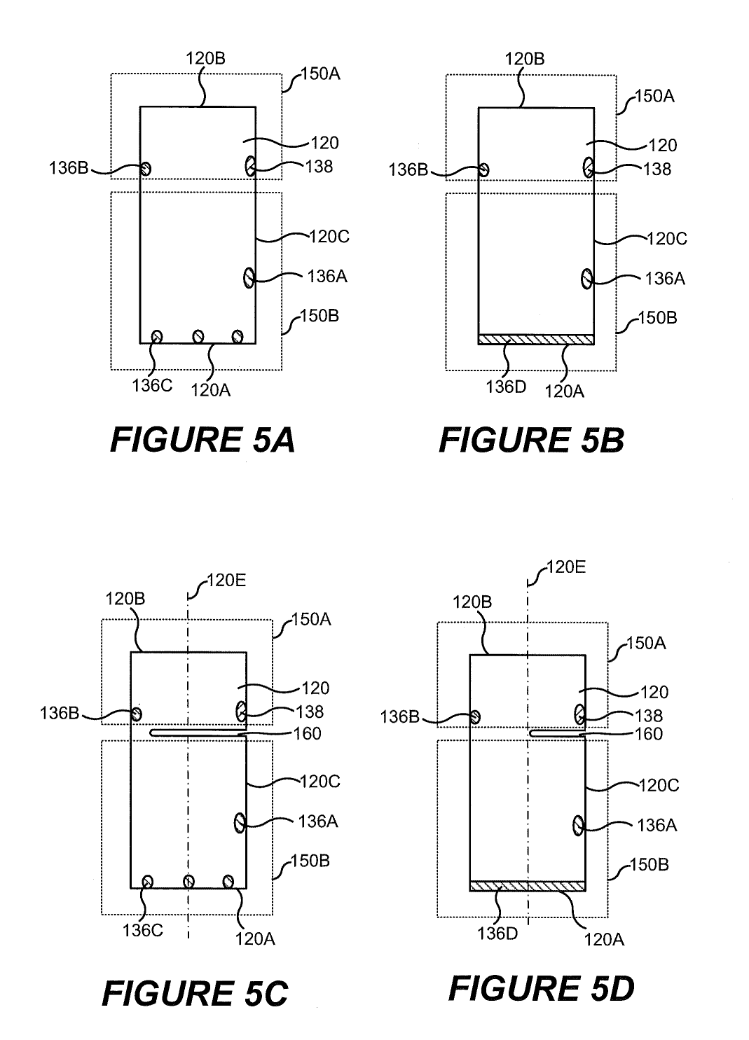

Referring to FIGS. 5A to 5D, the PIFA 150 provided by the conductive rear housing 120 of the device 100 may have many different configurations. For example, the antenna 150 may have a feed point 138 that is coupled to the conductive rear housing 120 at a point along a side 120C of the conductive rear housing 120 that runs from a first end 120A to a second end 120B of the conductive rear housing 120. The antenna 150 may include a plurality of ground connections, including one or more ground points 136C provided at the first end 120A of the conductive rear housing 120 (FIG. 5A), or a short circuit plate 136D provided at the first end 120A of the conductive rear housing 120 (FIG. 5B).

Additional ground points may be provided, for example, to enable the antenna 150 to have multiple resonant frequencies. For example, the antenna 150 may include a ground point 136A on the same side 120C as the feed point 138, and a ground point 136B on an opposite edge 120D from the edge 120C at which the feed point 138 is located. Accordingly, the antenna 150 may have a high frequency portion 150A that is tuned to resonate in a high frequency band and a low frequency portion 150B that is tuned to resonate in a lower frequency band.

By having multiple resonant frequencies, the antenna 150 may be configured to transmit/receive signals in multiple frequency bands, such as, for example, 800 MHz and 1.6 GHz cellular frequency bands, GPS frequency bands, etc., potentially avoiding the need and expense of providing separate antennas in the device 100.

Referring to FIGS. 5C and 5D, the conductive rear housing 120 may further include a slot 160 therein extending from the side 120C of the conductive rear housing 120 towards a longitudinal centerline 120E of the conductive rear housing 120. The slot 160 may reduce the resonant frequency of the antenna, and can also be used to provide an antenna for dual-frequency operation.

In some embodiments, the slot 160 may extend into the conductive rear housing from a point on the side 120C of the conductive rear housing 120 between the feed point 138 and the ground point 136A. The slot 160 may extend to a point near and/or past the longitudinal centerline 120E of the conductive rear housing 120, as illustrated in FIGS. 5C and 5D.

To provide structural support to the antenna 150 and to seal the internal space of the housing, the slot 140 may be filled with a dielectric material such as air, plastic, ceramic, etc.

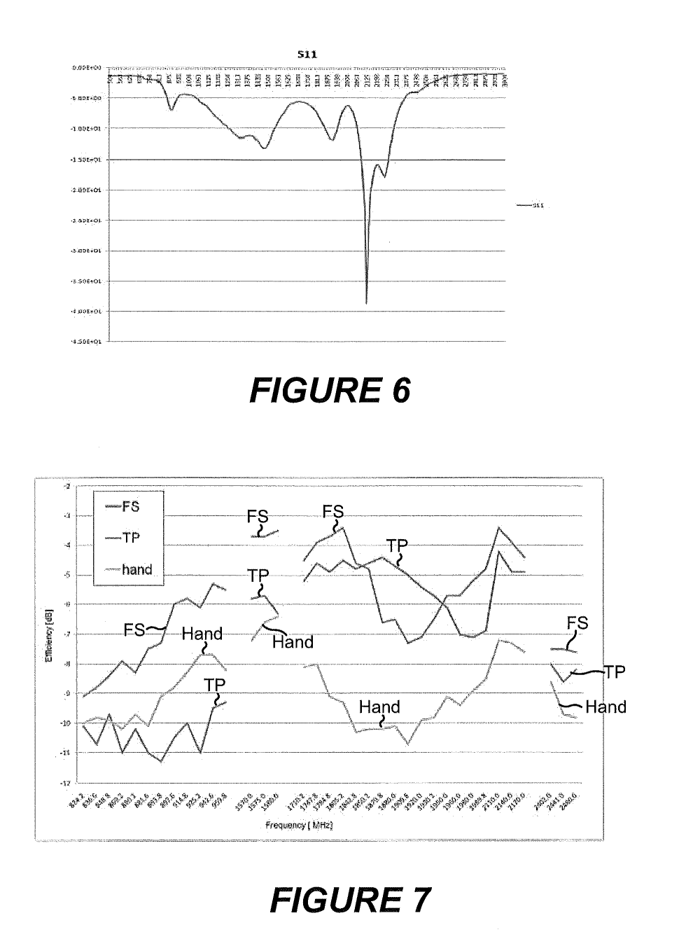

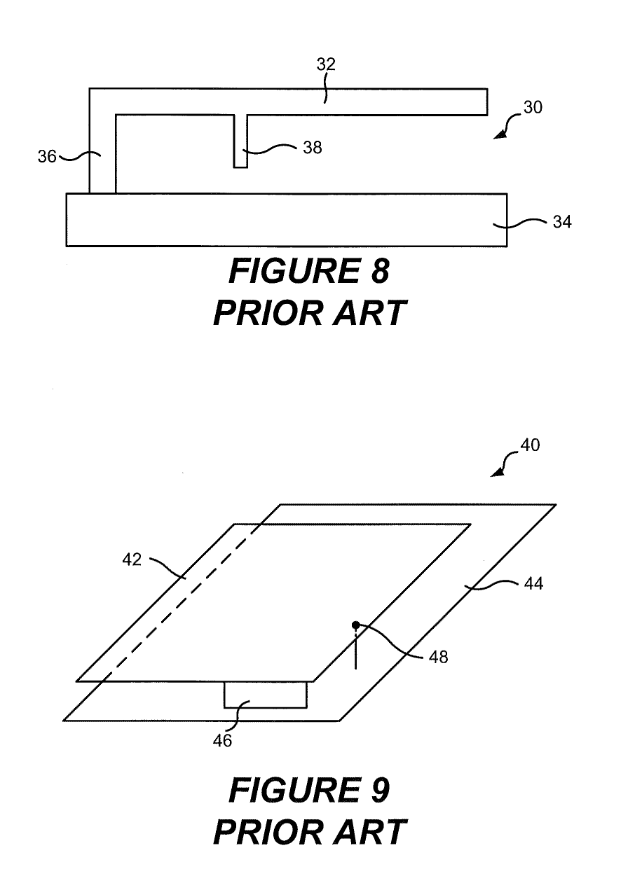

FIG. 6 illustrates return loss (S11) measurements for an exemplary wireless communication device having dimensions of 110 mm×60 mm×11 mm. FIG. 7 illustrates efficiency measurements for the exemplary device at various frequency bands, including 824-959 MHz, 1570-1580 MHz, 1710-2170 MHz, and 2402-2480 MHz, for free space (FS), talk position (TP), and hand position (Hand) configurations. The return loss measurements indicate that the −5 dB bandwidth of the antenna is large enough to cover many frequencies of interest. Further, the efficiency measurements indicate that the performance of the antenna is very good over the frequency ranges of interest, even when the radiating element of the antenna 150 is in contact with the user's hand.

A wireless communication device according to some embodiments including a housing portion that functions as a radiator for a planar inverted F antenna may exhibit acceptable RF performance while having reduced size and/or weight. Furthermore, the device may have a cosmetically pleasing appearance, as the back cover may be made metallic without shielding an internal antenna. An antenna according to some embodiments may be configured operate in multiple frequency bands, potentially further reducing the weight and/or cost of the device. Furthermore, the antenna may be less affected by hand positioning of the user, as the ground current may be split over a PWB and the rear housing of the device.

In some embodiments, the size of the radiating portion of the antenna may be significantly larger than the size of a conventional PIFA antenna provided within the housing of an electronic device. The current in the antenna may therefore be distributed over a larger area and may not be concentrated into one part of the antenna, so current distribution in the antenna may be less affected by the proximity of a user's hand. Thus, a device according to some embodiments may experience significantly lower hand effect (i.e., a modification in the antenna's properties resulting from the proximity of the user's hand) as compared to a conventional device.

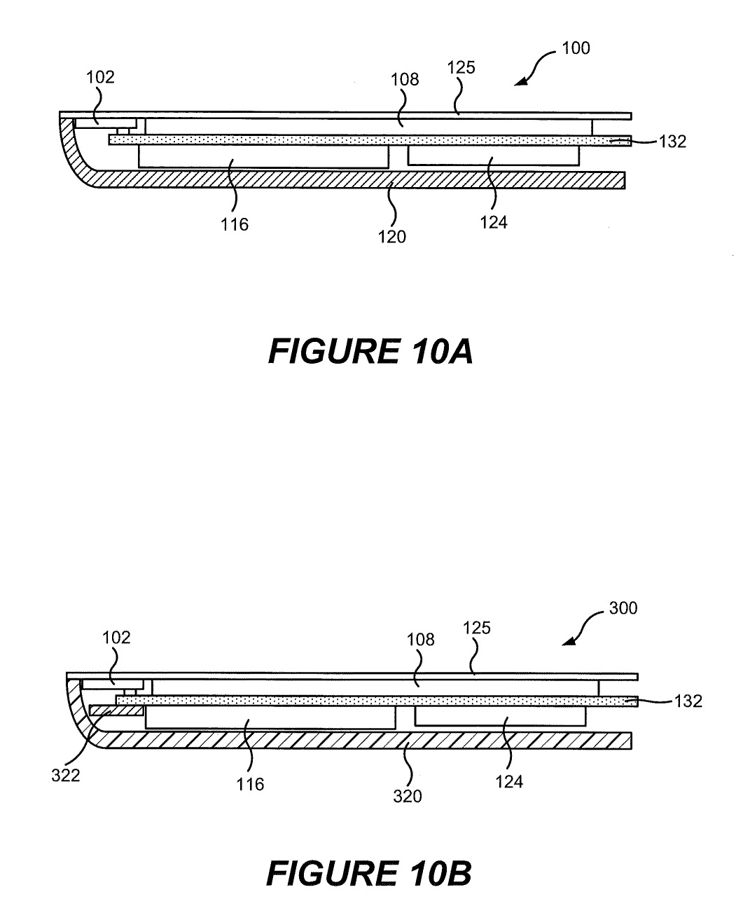

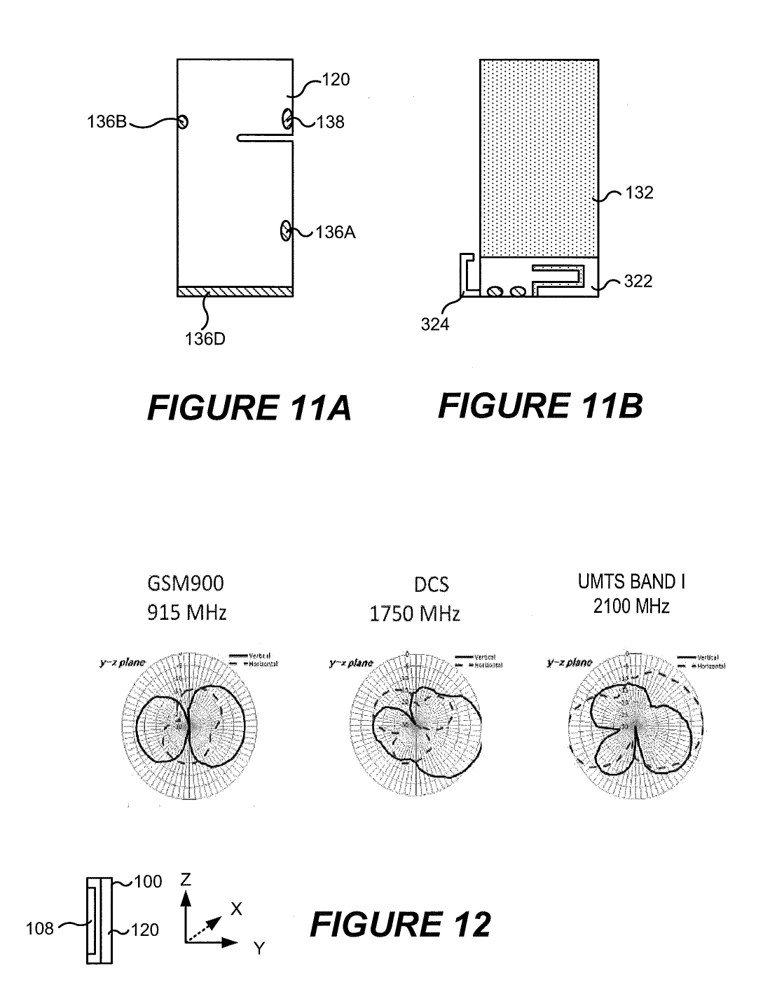

FIGS. 10A and 10B compare a device 100 according to some embodiments with a conventional device 300, while FIGS. 11A and 11B compare a conductive rear housing/antenna radiating element 120 according to some embodiments with a PIFA radiating element 322 in a conventional device.

Referring to FIG. 10A, a device 100 according to some embodiments includes a conductive rear housing/antenna radiating element 120, a front housing portion 125, which may include a glass plate, and a PWB 132 disposed within the housing defined by the conductive rear housing/antenna radiating element 120 and the front housing portion 125. A button 102 is operatively connected to the PWB, and a display 108, battery 116 and camera 124 are mounted on the PWB 132.

Referring to FIG. 10B, a conventional device 300 may include similar elements as the device 100, including a PWB 132, a button 102, a display 108, a battery 116 and a camera 124. However the device 300 includes a plastic or other non-conductive rear housing portion 320 and an antenna radiating element 322 disposed between the rear housing 320 and the PWB 132.

Referring to FIGS. 11A and 11B, the radiating element 322 of the conventional device may occupy only a small portion of the PWB 132.

As can be seen, the antenna radiating element 322 of the conventional device 300 may be confined to a small area of the device housing, which means that the proximity of a user's hand can significantly interfere with current distribution in the antenna, which can adversely affect the antenna's performance. For example, a conventional PIFA in a handheld electronic device may have dimensions of about 10-20 mm by about 5-10 mm. For this reason, it is common for conventional devices to include a parasitic radiating element 324.

In contrast, the radiating element of the antenna according to embodiments of the invention can cover a significantly larger area, and therefore may be less affected by the proximity of the user's hand and/or may not require the use of a parasitic element.

Similarly, when a conventional device is held in talk position close to a user's head, the antenna may experience a frequency shift due to the proximity of the user's head. However, an antenna according to some embodiments may be less affected by the user's head, due at least in part to the larger size of the radiating element.

Furthermore, a device according to some embodiments can have a radiation pattern that is biased towards the back of the device (i.e., the side of the device on which the antenna radiating element forms the back cover). FIG. 12 illustrates vertical (solid lines) and horizontal (dashed lines) radiation patterns for emissions from a device according to some embodiments using GSM900 915 MHz signals, DCS 1750 MHz signals, and UMTS Band I 2110 MHz signals. The radiation patterns are illustrated in the Y-Z plane relative to the orientation of the device 100 including a display 108 and a conductive rear housing 120 that serves as the radiating element of the device antenna. These figures show that the radiation pattern in these configurations is biased towards the back side of the device (positive Y direction).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A wireless communication device, comprising:
a housing including a first exterior portion and a second exterior portion defining a space therebetween for mounting electronic circuitry within the housing, wherein the second exterior portion of the housing comprises a conductive layer having a first end and a second end opposite the first end;
a printed wiring board within the housing, the printed wiring board comprising a ground plane and being spaced apart from the conductive layer;
an antenna feed element that electrically couples a lead on the printed wiring board to the conductive layer at a point that is displaced from the first end of the conductive layer towards a center of the conductive layer; and
a ground connection that electrically couples the conductive layer to the ground plane of the printed circuit board.

2. The wireless communication device of claim 1, wherein the conductive layer comprises a conductive outer cover of the wireless communication device.

3. The wireless communication device of claim 1, wherein the conductive layer provides a radiating element of a planar inverted F antenna for the wireless communication device.

4. The wireless communication device of claim 1, further comprising a display mounted on the first exterior portion of the housing and a conductive display frame configured to support the display, wherein the conductive display frame is electrically coupled to the ground plane of the printed circuit board and wherein the ground connection is connected to the display frame.

5. The wireless communication device of claim 1, wherein the ground connection is located at the second end of the conductive layer.

6. The wireless communication device of claim 5, further comprising an antenna feed point where the antenna feed element contacts the conductive layer on a first side of the conductive layer that runs between the first and second ends of the conductive layer, and a second ground connection on the first side of the conductive layer.

7. The wireless communication device of claim 6, further comprising a third ground connection on a second side of the conductive layer opposite the first side of the conductive layer.

8. The wireless communication device of claim 7, wherein the third ground connection is provided opposite the antenna feed point.

9. The wireless communication device of claim 1, further comprising a slot in the conductive layer extending from a side of the conductive layer towards a longitudinal centerline of the conductive layer, wherein the slot is free of conductive material, and wherein an antenna feed point where the antenna feed element contacts the conductive layer is on a first side of the conductive layer that runs between the first and second ends of the conductive layer and is adjacent the slot.

10. The wireless communication device of claim 9, wherein the ground connection is located at the second end of the conductive layer.

11. The wireless communication device of claim 10, further comprising a second ground connection on the first side of the conductive layer on an opposite side of the slot from the antenna feed point.

12. The wireless communication device of claim 11, further comprising a third ground connection on a second side of the conductive layer opposite the first side of the conductive layer.

13. The wireless communication device of claim 12, wherein the third ground connection is provided opposite the antenna feed point on the same side of the slot as the antenna feed point.

14. A housing for a wireless communication device, comprising:
a first exterior portion;
a second exterior portion defining a space therebetween for mounting electronic circuitry within the housing, wherein the second exterior portion of the housing comprises a conductive layer having a first end and a second end opposite the first end, wherein the second exterior portion comprises an antenna feed point at a point that is displaced from the first end of the conductive layer towards a center of the conductive layer and that is configured to receive an antenna feed element connection; and
a ground connection point that is configured to electrically couple the conductive layer to a ground plane.

15. The housing of claim 14, wherein the conductive layer comprises a conductive outer cover of the housing.

16. A wireless communication device, comprising:
a housing including a conductive exterior surface;
a ground plane within the housing and spaced apart from the conductive exterior surface;
an antenna feed element that electrically couples an RF signal lead to the conductive exterior surface; and
a ground connection that electrically couples the conductive exterior surface to the ground plane;
wherein the conductive exterior surface provides a radiating element of a planar inverted F antenna for the wireless communication device.

17. The wireless communication device of claim 16, wherein the ground plane comprises a ground plane layer of a printed wiring board that is disposed within the housing.

18. The wireless communication device of claim 17, further comprising a ground plane extension that is electrically coupled to the ground plane, wherein the conductive exterior surface is coupled to the ground plane through the ground plane extension.

19. The wireless communication device of claim 16, further comprising a slot in the conductive outer surface extending from a side of the conductive outer surface towards a longitudinal centerline of the conductive outer surface, wherein the slot is free of conductive material, and wherein an antenna feed point where the antenna feed element contacts the conductive layer is on a side of the conductive layer that runs between first and second ends of the conductive outer surface and is adjacent the slot.

20. The wireless communication device of claim 16, further comprising a display mounted on the housing and a conductive display frame configured to support the display, wherein the conductive display frame is electrically coupled to the ground plane and wherein the ground connection is connected to the display frame.
